(19) United States
(12) Patent Application Publication
(10) Pub. No.: US 2007/0002469 A1
(43) Pub. Date: Jan. 4, 2007

(54) Lens barrel and camera

(75) Inventor: Masao Matsugae, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Opto, Inc., Tokyo (JP)

(21) Appl. No.: 11/477,330

(22) Filed: Jun. 28, 2006

(30) Foreign Application Priority Data
Jul. 4, 2005 (JP) JP2005-194742

(51) Int. Cl. G02B 7/02

(52) U.S. Cl. 359/811

(57) ABSTRACT

A lens barrel is provided with: a fixed barrel including a first straight guide; a cam cylinder supported by the fixed barrel and including a cam groove formed on an internal circumference of the can cylinder; a front cylinder including a lens, a can pin for being engaged with the cam groove, and at least three extended portions formed by partly extending an end surface of the front cylinder; and a straight guide member engaged with the first straight guide. When the lens barrel reaches a second state from a first state, an end surface of each of the extended portions is positioned closer to the image plane side than an object side surface of a predefined region of the straight guide member.

This application is based on Japanese Patent Application No. 2005-194742 filed on Jul. 4, 2005, in Japanese Patent Office, the entire content of which is hereby incorporated by reference.

### Technical Field

The present invention relates to a lens barrel, and in particular, to a lens barrel constructed to be collapsible in which a lens group is moved by a rotation of a cam cylinder on an optical axis, and to a camera which employs the lens barrel.

### BACKGROUND

The camera which employs a lens barrel of the so-called collapsible type has been used generally. The lens barrel of collapsible type is provided with lens groups each being an optical element forming an image taking optical system and the lens groups is housed thin in the camera body by shortening a distance between the lens groups when the camera is not used to photographing so that the camera may be excellent in convenience when it is carried.

As a lens barrel of this collapsible type, there is disclosed a lens barrel collapsible from a photographing state to a non-photographing state which is provided with a fixed barrel with a cam groove formed on its inner circumferential surface; a cam cylinder having a cam pin engaging with the cam groove on the fixed barrel on its outer circumferential surface and a cam groove on its inner circumferential surface supported movably in the optical axis direction and rotatably by the fixed barrel; a front cylinder with a cam pin engaging with the cam groove on the inner circumferential surface of the cam cylinder; a straight guide supporting plate that engaging with a straight guide portion formed on the fixed barrel, and moving straight accompanying movement of the cam cylinder in the optical axis direction; and a straight guide ring fixed on the straight guide supporting plate and moving straight accompanying movement of the cam cylinder in the optical axis direction (for example, see TOKUKAI No. 2003-227992, FIGS. 1 and 2).

The lens barrel described in the aforesaid Patent Document is collapsed when the lens barrel is not used for photographing to be excellent in convenience for portable use.

However, as shown in FIG. 2 of the aforesaid Patent Document, an end surface of the front cylinder facing the image plane side is formed to be at the position where it does not interfere with the straight guide supporting plate (a straight guide plate) supporting the straight guide ring in the optical axis direction, when the lens is retracted and the lens barrel is in the collapsed state. While, as shown in FIG. 1 of the aforesaid Patent Document, the front cylinder is drawn out when it is in the photographing state, therefore, a length of the engagement portion between the front cylinder and the straight guide ring in the optical axis direction is reduced by a drawn-out length.

When the length of the engagement portion is secured to be longer, each of lens groups is positioned more accurately according to the optical axis alignment when the lens barrel is drawn out. However, the longer engagement portion increases thickness of the lens barrel along the optical axis when the lens barrel is collapsed, which is a problem. Contrary to the foregoing, providing the thinner lens barrel when the lens barrel is collapsed shortens the length of the engagement portion when the lens barrel is drawn out as the photographing state. It reduces the accuracy of the optical axis alignment of each lens groups, which is another problem.

### SUMMARY

In view of the aforesaid problems, an object of the invention is to obtain a lens barrel being thinner when the lens barrel is collapsed and securing enough length of the engagement portion when the lens barrel is drawn out, and providing lens groups positioned more accurately for the optical axis alignment when the lens barrel is drawn out, and to obtain a camera equipped with that lens barrel.

The above problems are solved by the following embodiments:
(Item 1) A lens barrel provided with: a fixed barrel including a first straight guide; a cam cylinder supported by the fixed barrel movably along an optical axis and rotatably and comprising a cam groove formed on an internal circumference of the cam cylinder; a front cylinder including a lens, a cam pin for being engaged with the cam groove, and at least three extended portions formed by partly extending an end surface of the front cylinder facing an image plane; a straight guide member engaged with the first straight guide and moving straight accompanying movement of the cam cylinder along the optical axis. When the lens barrel reaches a second state in which the lens barrel is collapsed from a first state in which the front cylinder is drawn out from the cam cylinder, an end surface of each of the extended portions is positioned closer to the image plane side than an object side surface of a region of the straight guide member overlapped to the cam cylinder in a direction of the optical axis.
(Item 2) The lens barrel described in Item 1 in which the extended portions are formed along a circle so as to divide a circumference of the circle into equal angular intervals.
(Item 3) The lens barrel described in Item 1 or 2, further provided with: a second straight guide for guiding the front cylinder straight and formed in the straight guide member.
(Item 4) A camera provided with the lens barrel described in any one of Items 1 to 3.

The invention provides a lens barrel and a camera having thinner dimension when the lens barrel is collapsed, securing enough length of the engagement portion when the lens barrel is drawn out, and including lens groups positioned more accurately for the optical axis alignment when the lens barrel is drawn out.

While the preferred embodiments of the present invention have been described using specific terms, such description is for illustrative purposes only, and it is to be understood that changes and variations may be made without departing from the sprit or scope of the appended claims.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

Each of FIGS. 1(a) and 1(b) is an external view showing an example of a camera carrying the lens barrel according to the invention;

FIG. 2 is a schematic longitudinal section showing the example of a camera with the lens barrel according to the present embodiment drawn out, representing the photographing state;

FIG. 3 is a schematic longitudinal section showing the example of a camera with the lens barrel according to the present embodiment collapsed, representing non-photographing state;

FIG. 4 is a perspective view showing a front cylinder according to the present embodiment as a component;

Each of FIGS. 5(a) and 5(b) is a partial sectional view showing positional relationship of a extended portion formed in the end surface of the front cylinder facing the image surface side, a straight moving member, a straight guide plate and a cam cylinder and when the lens barrel is collapsed; and

FIG. 6 is a front view showing positional relationship of a straight guide plate, a straight moving member and a extended portion formed on the front cylinder when the lens barrel is collapsed.

### DESCRIPTION OF THE PREFERRED EMBODIMENT

The embodiment according to the invention will be explained in detail as follows, however, it does not limit the scope of the present invention.

Each of FIGS. 1(a) and 1(b) is an external view showing an example of a camera carrying lens barrel 80 according to the invention. FIG. 1(a) is a perspective view of the front surface of the camera and FIG. 1(b) is a perspective view of the rear surface of the camera.

In FIG. 1(a), the numeral 80 represents a lens barrel of a collapsed type according to the invention. The numeral 82 represents a viewfinder window, 83 represents a release button, 84 represents a light emitting portion of a flash, 86 represents a microphone, 87 represents a strap holder and 88 represents a USB terminal. The numeral 89 represents a lens cover, and the lens barrel 80 is collapsed under the non-photographing state.

In FIG. 1(b), the numeral 91 represents a viewfinder eye piece and 92 represents a indicator having red and green portions indicating AF or AE information to a photographer through emission of light or through blinking when release button 83 is depressed. The numeral 93 represents a zoom button for performing zoom up operation and zoom down operation, 94 represents a speaker for reproducing sound recorded by the microphone 86 or shutter-release sound. The numeral 95 represents a menu/set button, 96 represents a selection button that is a four-way switch and 100 represents monitor LCD that displays images and other character information. These provide functions such that the “menu/set” button 95 makes display various types of menus on the monitor LCD, selection button 96 selects a menu, and the menu/set button 95 determines the selected menu. The numeral 97 represents a reproduction button that reproduces photographed images, 98 represents a display button that selects displaying operation or deleting operation of images and other character information displayed on the monitor LCD 100, 99 represents an erasure button that erases images photographed and recorded, 101 represents a hole for a tripod and 102 represents a battery/card cover. The battery/card cover 102 is arranged so that a battery for supplying power source for the present camera and a card type removable memory for storing photographed images may be loaded in the inside thereof.

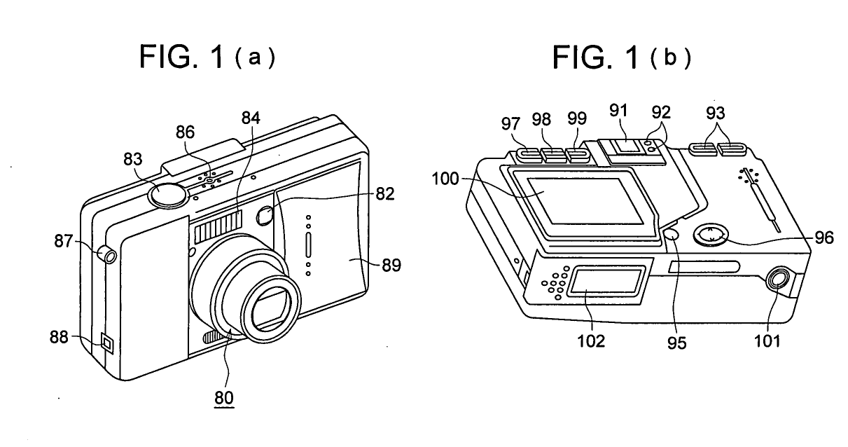

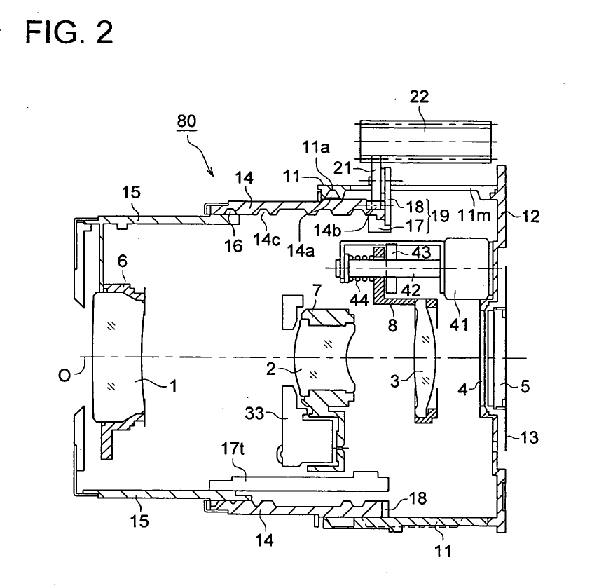

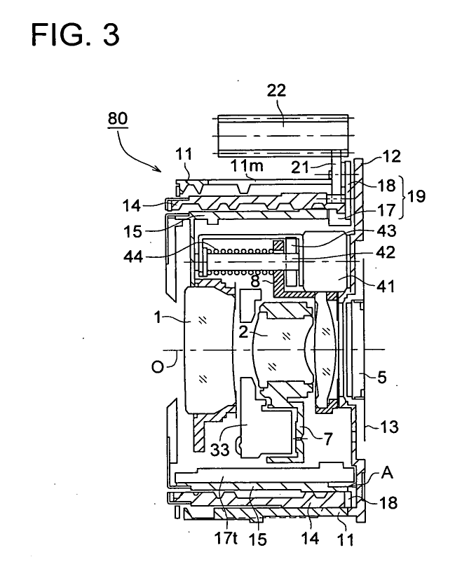

First, a schematic total structure and operations in outline of a lens barrel according to the invention will be explained, referring to FIG. 2 and FIG. 3.

FIG. 2 is a schematic longitudinal section showing a camera with the lens barrel 80 according to the present embodiment and the lens barrel 80 is drawn out, representing an example of the photographing state (first state). FIG. 2 shows the lens barrel 80 positioned under the wide-angle end state. FIG. 3 is a schematic longitudinal section showing a camera with the lens barrel 80 according to the present embodiment and the lens barrel 80 is collapsed, representing an example of the non-photographing state (second state). Incidentally, in the drawings of the present invention, the explanation will be given by giving the same symbols to the members having the same functions, for avoiding overlapping of the explanations.

In FIGS. 2 and 3, the numeral 1 represents the first lens group, 2 represents the second lens group, 3 represents the third lens group. Therefore lens barrel 80 includes an image-taking lens formed of three lens groups. First lens group 1 and second lens group 2 are moved in the optical axis direction for zooming operation, while, third lens group 3 is moved in the optical axis direction for focusing operation. Further, 4 represents OLPF (Optical Low Pass Filter) which removes high frequency component of object light for preventing false colors and moiré. The numeral 5 represents an image sensor that photoelectrically converts object light formed as an optical image in the image sensor, for example, CCD (Charge Coupled Device) type image sensor or CMOS (Complementary Metal-Oxide Semiconductor) type image sensor.

The first lens group 1 is supported by the first lens frame 6, the second lens group 2 is supported by the second lens frame 7 and the third lens group 3 is supported by the third lens frame 8.

The numeral 11 represents a fixed barrel which is fixed solidly on a camera main body, and has cam groove 11a on its internal circumstance. The fixed barrel is provided with base plate 12 fixed on the rear portion threof. The base plate 12 is provided with OLPF 4 and image sensor 5 mounted in sequence thereon. The image sensor 5 is connected electrically to printed board 13.

The numeral 14 represents a cam cylinder, and on its outer circumferential surface, there is formed cam pin 14a that engages with cam groove 11a of the fixed barrel 11. On a part of the rear portion of the cam cylinder, there is formed partial gear 14b. On the internal circumstance of the cam cylinder, there is formed cam groove 14c.

The numeral 15 represents a front cylinder that holds the first lens frame 6. On the outer circumferential surface of the front cylinder 15, three cam pins 16 which are made of metal are implanted to engage with cam groove 14c of cam cylinder 14.

A cam pin is implanted also on the second lens frame 7, although the cam pin is not illustrated, and it is engaged with a cam groove that is different from cam groove 14c of cam cylinder 14.

On the cam cylinder 14, there is assembled straight guide member 19 including straight moving member 17 and straight guide plate 18, so as to be rotatable and to be movable in the optical axis direction accompanying movement of the cam cylinder 14. The straight guide plate 18 is engaged with straight guide section 11m (first straight guide) as shown FIGS. 2 and 3, and it further supports driving gear 21 rotatably that engages with partial gear 14b. The driving gear 21 is engaged with long gear 22. The long gear 22 is driven by an unillustrated motor and a speed reducing gear train.

The straight guide plate 18 of the straight guide member 19 comes in contact with a ring-shaped surface of the cam cylinder 14 facing the image sensor 5 side to slide thereon, while, the straight moving member 17 of the straight guide member 19 comes in contact with an inner surface of the cam cylinder 14 to slide thereon. Further, on the straight moving member 17 of straight guide member 19, there is formed straight guide section 17t (second straight guide) that engages with front cylinder 15 and second lens group frame 7 for guiding them straight. The numeral 33 represents a diaphragm shutter unit which is fixed on the second lens group frame 7. Otherwise, there also may be provided the structure that the straight guide section 17t guides the front cylinder to move straight, and the front cylinder 15 moving straight engages with the second lens group frame 7 to guide the second lens group frame 7 to move straight.

The numeral 41 represents a focus motor to which feeding screw 42 is connected. The feeding screw 42 is screwed in nut 43 whose rotation is regulated, and an arm portion of third lens group frame 8 is pressed by spring 44 against the nut 43. Owing to this, when the feeding screw 42 is rotated by the focus motor 41, the nut 43 moves in the optical axis O direction, whereby, the third lens group frame 8 is moved in the optical axis O direction, and it causes movements for focusing operation and collapsing operation.

In order that the above structure reaches to the telephoto end state from the wide-angle end state shown in FIG. 2, an unillustrated motor is driven to be rotated in the prescribed direction and the cam cylinder 14 is rotated by long gear 22 and driving gear 21. Due to this, both of the front cylinder 15 with cam pin 16 engaged with cam groove 14c formed on an internal circumference of the cam cylinder and fixed on the straight guide section 17t; and the second lens group frame 7 engaged with an unillustrated cam groove formed on the cam cylinder 14 move in the optical axis O direction with being guided straight by the straight guide section 17t for zooming operation.

On the other hand, in order that the above structure reaches to the collapsed state (second state) shown FIG. 3 from the wide-angle end state shown in FIG. 2, focus motor 41 is first driven to move third lens group frame 8 to the image sensor 5 side, and then, an unillustrated motor is driven to rotate inversely so that the cam cylinder 14 may be rotated inversely by long gear 22 and driving gear 21. Owing to this, the cam cylinder 14 is guided by cam groove 11a formed on fixed barrel 11 to move toward the image sensor 5 side. Both of the front cylinder 15 including cam pin 16 engaged with cam groove 14c formed on an inner circumferential surface of the cam cylinder and fixed on the front cylinder 15; and the second lens group frame 7 engaged with an unillustrated cam groove formed on the cam cylinder 14 moves toward the image sensor 5 with being guided straight by the straight guide section 17t. Therefore, the illustrated collapsed state is provided. In this case, straight guide member 19 including straight moving member 17 and straight guide plate 18 moves straight accompanying the movement of cam cylinder 14, and the front cylinder 15 retreats into the cam cylinder 14. Further, the front cylinder 15 may either be housed totally in the cam cylinder 14 as shown in FIG. 3, or a part of the front cylinder 15 may be exposed from the cam cylinder 14.

The foregoing represents a schematic structured of the total lens barrel 80 according to the present embodiment and an outline of operations.

In the collapsed state of the lens barrel 80 according to the present embodiment, a part of an end surface of the front cylinder 15 is protruded toward the image plane side comparing to the object side surface of the straight guide plate 18 (the object side surface of a region of the straight guide member overlapped to the cam cylinder in a direction of the optical axis), as shown at the position marked with arrow A in FIG. 3, which is different from the collapsed state of a conventional lens barrel.

Relationship of an end surface of the front cylinder 15 facing the image plane side, straight moving member 17, straight guide plate 18 and the cam cylinder 14, in the collapsed state of the lens barrel 80 according to the present embodiment will be explained more minutely as follows.

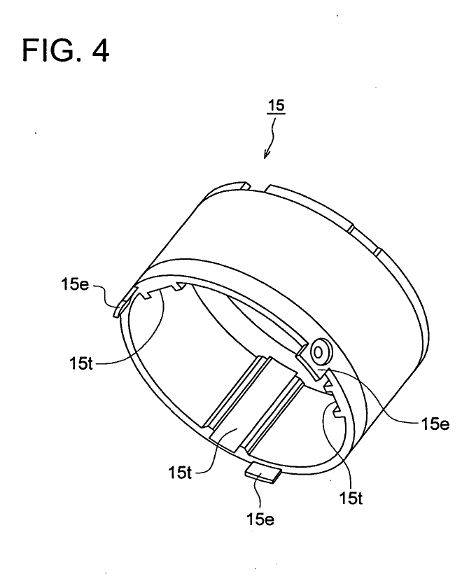

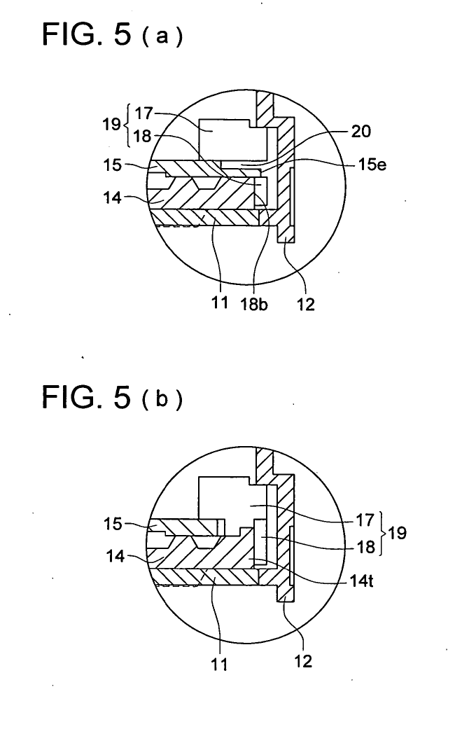

FIG. 4 is a perspective view showing a front cylinder 15 according to the present embodiment as a component. Fig. 4 is a diagram wherein the front cylinder 15 is viewed from the image plane side, namely, from the upper part on the image sensor side.

As shown in FIG. 4, there are formed extended portions 15e which are partly extended from the end surface of the front cylinder facing the image plane side. In the present example, although the explanation is given under the condition that three extended portions 15e are formed as illustrated, three or more extended portions 15e may also be formed. Further, it is preferable that the extended portions 15e are formed along a circle and a circumference of the circle is equally divided into angular intervals. However, it is naturally shown that the extended portions 15e are unnecessary formed to be divide it strictly equally.

Further, on the internal circumference of the front cylinder 15, there is formed groove portion 15t that engages with straight guide section 17t formed on the straight moving member 17.

Each of FIGS. 5(a) and 5(b) is a partial sectional view showing positional relationship for a straight moving member 17 in straight guide member 19, a straight guide plate 18 and a cam cylinder 14. FIG. 5(a) shows a sectional view passing through the extended portion 15e, and FIG. 5(b) shows a sectional view passing through portions excluding the extended portion 15e. Further, regarding FIGS. 5(a) and 5(b), the right side on the page is the image side, and the left side on the page is the object side.

As shown in FIG. 5(a), the extended portion 15e formed on the front cylinder 15 enters airspace 20 formed between straight guide plate 18 and straight moving member 17 when the lens barrel is collapsed, and it stops when a tip of the extended portion comes to the position that is closer to the image plane side than the object side surface 18b of the straight guide plate 18 on the object side, namely, it stops when the end surface of the extended portion comes to the position that is closer to the image plane side than the object side surface of the portion of straight guide member 19 overlapped to the cam cylinder 14 in the optical axis direction.

Further, as shown in FIG. 5(b), an end surface of the front cylinder 15 facing the image plane side excluding the extended portion 15e is arranged to stop at a position closer to the object side than the object side surface of the straight guide plate 18, namely, the portion of straight guide member 19 overlapped to the cam cylinder 14 in the optical axis direction.

Incidentally, the conventional embodiment provides a positional relationship shown in FIG. 5(b) on the entire circumference of the end surface of the front cylinder.

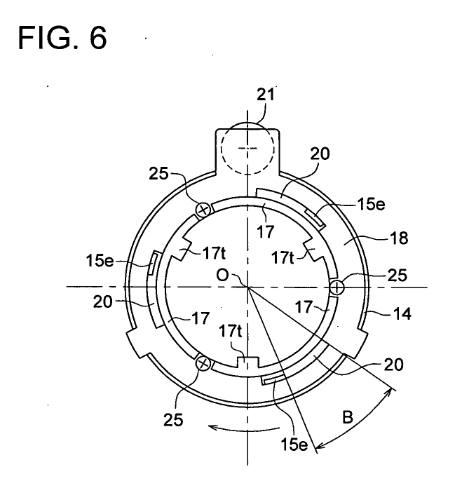

FIG. 6 is a front view showing positional relationship for a straight guide plate 18, a straight moving member 17 and extended portions 15e that are formed on the front cylinder 15 when the lens barrel is collapsed. FIG. 6 is a diagram showing positional relationship that is viewed from the image plane side after straight guide plate 18, straight moving member 17, cam cylinder 14 and front cylinder 15 are removed.

Set screws 25 shown in FIG. 6 combine straight guide plate 18 with straight moving member 17 to slidably interpose convex portion 14t (see FIG. 5(b)) formed on cam cylinder 14, whereby, such a structure allows that the cam cylinder 14 is rotated, and straight guide member 19 including straight guide plate 18 and straight moving member 17 moves straight accompanying the movement of the cam cylinder 14 in the optical axis direction.

As shown in FIG. 6, on each of the straight guide plate 18 and the straight moving member 17, there are formed three airspaces 20 (see FIG. 5(a)), and each extended portion 15e of the front cylinder 15 is positioned in the airspace 20 when the lens barrel is collapsed.

For switching from the collapsed state (second state) to the state where the lens barrel is drawn out (first state), cam cylinder 14 is rotated in the illustrated arrow direction by driving gear 21. The cam cylinder 14 moves in the optical axis O direction to be rotated compared to the position of the fix barrel while being guided by a cam groove formed on the fixed barrel. In this case, the straight guide plate 18, the straight moving member 17 and the front cylinder 15 move straight accompanying the movement of the cam cylinder 14 in the optical axis O direction. Further, the front cylinder 15 is guided by a cam groove formed on an inter circumference of the cam cylinder 14 and by straight guide section 17t (second straight guide), and moves straight toward the object side even for the cam cylinder 14.

The cam groove on the cam cylinder 14 is formed so that extended portion 15e may be drawn out from the cam cylinder 14 not to be interfere with convex portion 14t formed on the cam cylinder 14 (see FIG. 5(b)) after the rotation of the cam cylinder 14 within illustrated angle B representing a surplus of the airspace 20, in this case.

As stated above, when the extended portion extended partly is formed on an edge surface of the front cylinder on the image plane side, and an end surface of each of the extended portions is positioned closer to the image plane side than an object side surface of the straight guide plate (a region of the straight guide member overlapped to the cam cylinder in a direction of the optical axis), in the collapsed lens barrel (second state), a thickness of the collapsed lens barrel in the optical axis direction is made to be the same as the conventional one. It secures the length of engagement portion of the cam cylinder and the front cylinder in the lens barrel drawn out under the photographing state to be longer than the conventional embodiment by a length equivalent to a length of the extended portion. Therefore, it is possible to obtain a lens barrel providing accurate positioning in the optical axis alignment for respective lens groups when the lens barrel is drawn out. Further, it provides an effect that a lens barrel which is further strengthened against a shock in the direction perpendicular to the optical axis because a length of engagement portion can be secured to be longer than ever before.

When a length of engagement portion of the cam cylinder and the front cylinder of the lens barrel drawn out under the photographing state is set to be the same as that in the conventional embodiment, it is possible to make a thickness of the collapsed lens barrel to be thinner than that of the conventional embodiment.

Though the above explanation of the embodiment provides a lens barrel with three extended portions, it does not limit the scope of the present invention. The aforesaid effect can be obtained enough when three or more extended portions are formed. Further, though the explanation provides the example in which a straight guide portion (second straight guide portion) guiding straight the front cylinder is formed on the straight moving member in the straight guide member, it is also possible to form a straight guide portion on the straight guide plate, and to form a straight moving member to be in a form of a ring. There also may be provided the straight guide member solidly formed of a straight guide plate and a straight moving member as one body. Though the explanation has been given under the example in which the end surface of the extended portion stops at a position between a surface facing the object side and a surface facing the image plane side both of the straight guide plate, it is also possible to arrange so that the end surface of the extended portion stops to be protruded from the surface of the straight guide plate facing the image plane side. In this case, the length of engagement portion when the lens barrel is drawn out can be secured to be further longer.

What is claimed is:

1. A lens barrel comprising:
a fixed barrel comprising a first straight guide;
a cam cylinder supported by the fixed barrel movably along an optical axis and rotatably and comprising a cam groove formed on an internal circumference of the cam cylinder;
a front cylinder comprising
a lens,
a cam pin for being engaged with the cam groove, and
at least three extended portions formed by partly extending an end surface of the front cylinder facing an image plane; and
a straight guide member engaged with the first straight guide and moving straight accompanying movement of the cam cylinder along the optical axis,
wherein when the lens barrel reaches a second state in which the lens barrel is collapsed from a first state in which the front cylinder is drawn out from the cam cylinder,
an end surface of each of the extended portions is positioned closer to the image plane side than an object side surface of a region of the straight guide member overlapped to the cam cylinder in a direction of the optical axis.

2. The lens barrel of claim 1,
wherein the extended portions are formed along a circle so as to divide a circumference of the circle into equal angular intervals.

3. The lens barrel of claim 1, further comprising:
a second straight guide for guiding the front cylinder straight, formed in the straight guide member.

4. A camera comprising the lens barrel of claim 1.
